(19) United States
(12) Patent Application Publication
(10) Pub. No.: US 2006/0148566 A1
(43) Pub. Date: Jul. 6, 2006

(54) Method and apparatus of an extended Cell-A-Lot sales lead enhancement and customer loyalty system

(76) Inventor: Arkalgud N. Lakshminarasimha, Marietta, GA (US)

Correspondence Address: ARKALGUD N. LAKSHMINARASIMHA, 2477 DEVON WOOD WAY, MARIETTA, GA, 30066, US

(21) Appl. No.: 11/025,069

(22) Filed: Dec. 30, 2004

(51) Int. Cl. A63F 13/00

(52) U.S. Cl. 463/42; 463/41

(57) ABSTRACT

In a previous patent disclosure, Provisional Patent Application # 60/402,812 Dated Aug. 12, 2002, Cell-A-Lot™ a method of ticketing retaining anonymity, authenticity and security is described. Method and Apparatus for customer loyalty program for airline ticketing, ticketing for games, Disney, car rentals and general retailing is described in Patent Pending 60/510,400 Oct. 14, 2003. Additional details of sales integration are disclosed and covered by this patent. The system architecture and usage example for flower sales is described below. Ticket sales for recreation usage such as Disney and game ticketing uses similar procedure. General product sales, sales lead and customer loyalty methods and apparatus using interactive cell phones, Internet and IVR are covered under this patent.

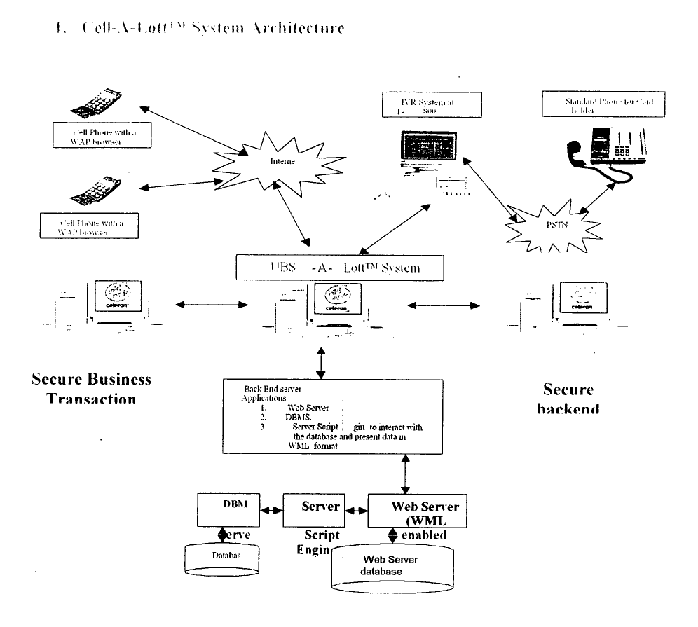

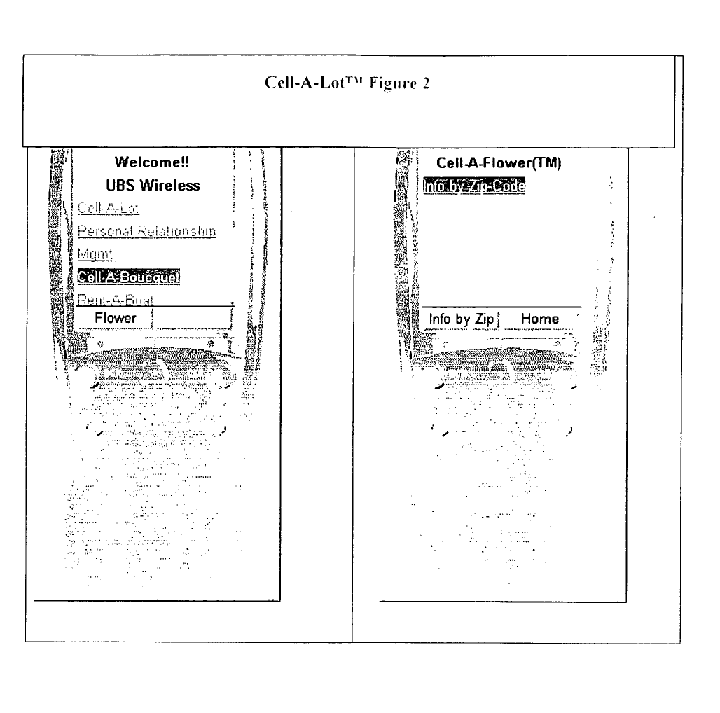

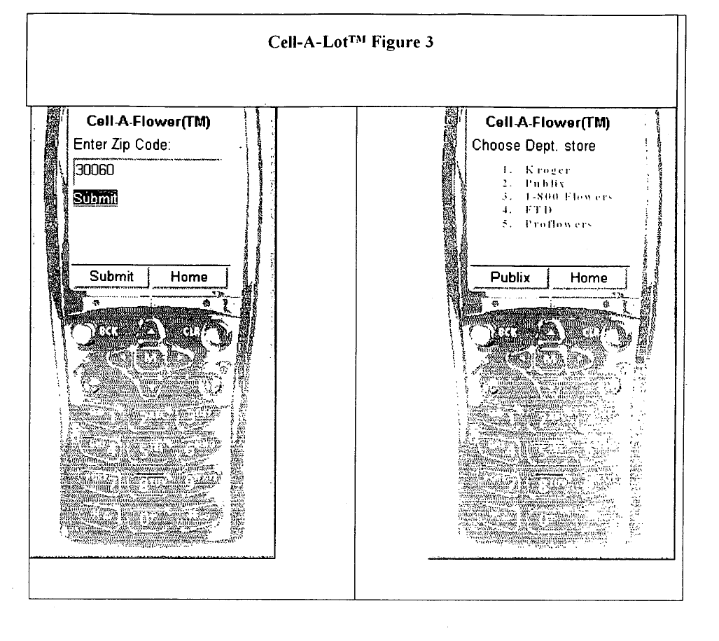

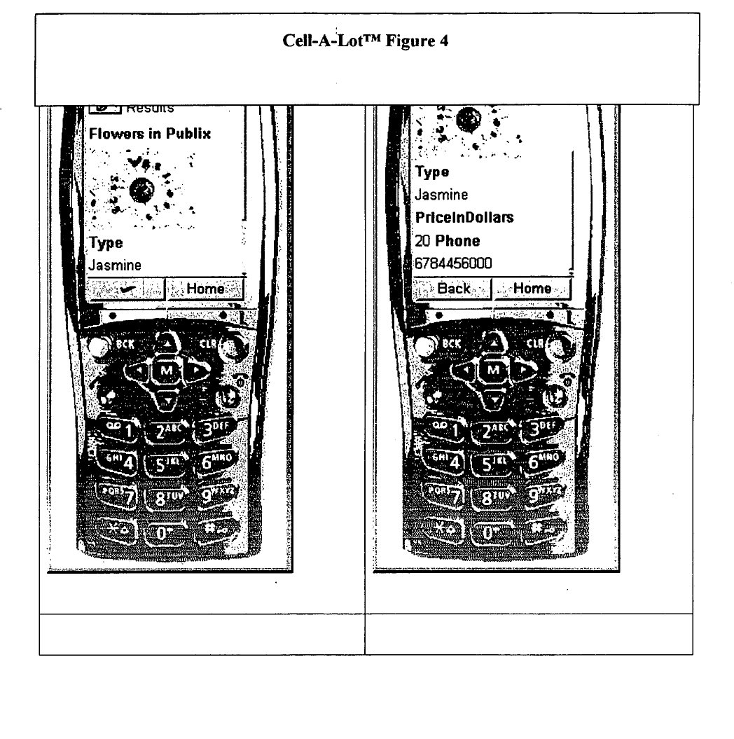

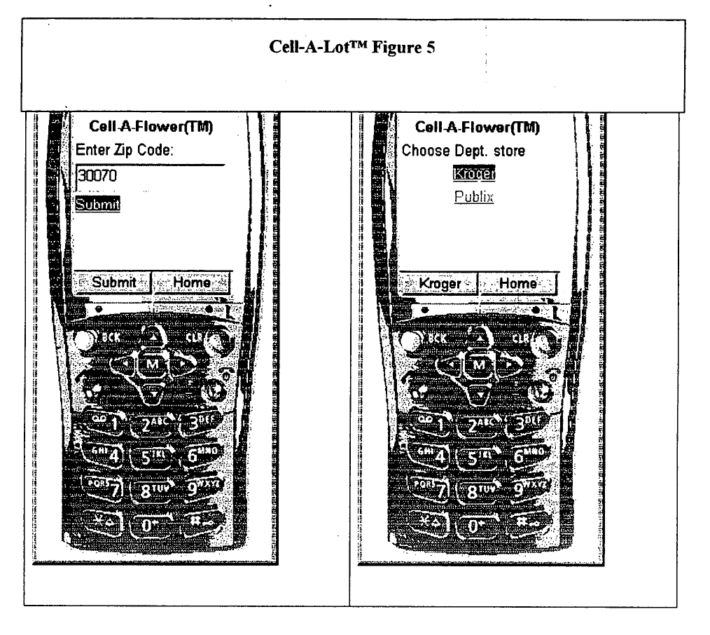

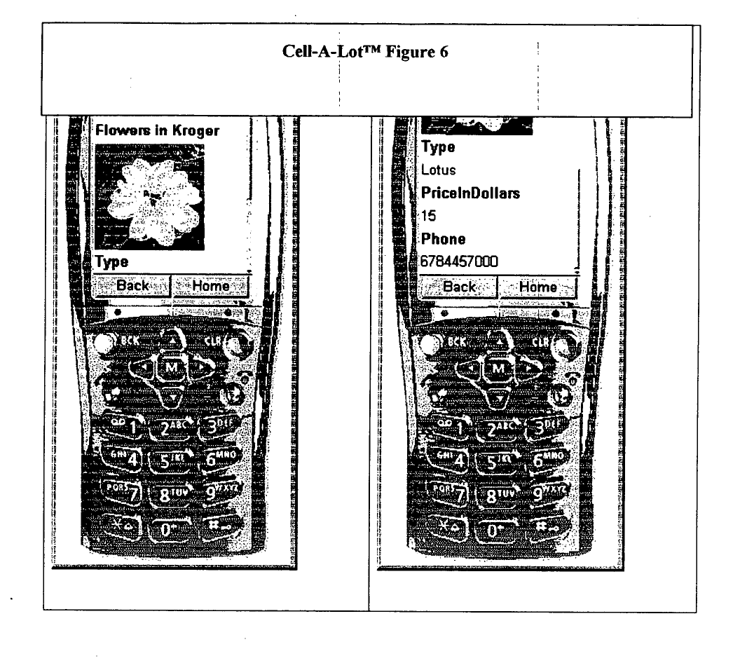

Cell-A-Lot™ system architecture (ref 1) is shown in FIG. 1. FIG. 2 through FIG. 6 shows steps of identification of a flower shop within a zip code and what types of flowers are available in a particular store, providing visual imaging, pricing information etc. Similar features are also available via Internet, as described in Patent disclosure 1. Purchase transaction is captured, viewable and verifiable via multiple mechanisms. A customer loyalty program, affiliate program which attracts customer to the site for example via regulated lottery gift or secondary product sale program and its advertising is covered under this patent. Core theme of customer loyalty which is covered under this intellectual property is a gift or a secondary product sale which helps fund a worthy cause, in which customer is not purchasing a lottery ticket, but is obtained delivered as a gift. The business transaction is helping a worthy cause by virtue of the process. The cell-a-lot provides unique mechanism for anonymity, authenticity and proof of purchase mechanism. The process of customer loyalty gift packaging, integrated the sale with fulfillment center, and delivery mechanism which provides additional mechanism for proof of age, pool purchase mechanism for certain gift products are covered under this intellectual property. Selection of specific stores or types of stores which already has these infrastructure in place for specific gifts, delivery and fulfillment center are also covered under this intellectual property. Development of—Internet or brick and mortar franchise using methods described are also covered under this patent.

### BACKGROUND OF THE INVENTION

In a previous patent disclosure, Provisional Patent Application # 60/402,812 Dated Aug. 12, 2002, Cell-A-Lot™ a method of ticketing retaining anonymity, authenticity and security is described. Method and Apparatus for customer loyalty program for airline ticketing, ticketing for games, Disney, car rentals and general retailing is described in Patent Pending 60/510,400 Oct. 14, 2003. Additional details of sales integration are disclosed and covered by this patent. Advertising, sales enhancement and customer loyalty of products are enhanced through the use of lottery gift program. This process helps regulated lottery to fund various worthy cause program undertaken by various state and central government agencies.

Product sale enhancement using lottery gift program when used with certain products can act as sub-franchise process. This could include Compact Disc music or movie rental sales, enhancement where lottery tickets sale can be included as a secondary product to enhance sales. A second example would be movie, Disney or game tickets combined with lottery tickets. A third example is to include lottery ticket sales in independent mail centers retail locations.

Lottery ticket sales through Internet and cell phones, phones and PDA has been explained in reference 1. A pool method where people agree to rules and guidelines of lottery ticket purchase using Internet, cell phones or phones or any remote device, where order fulfillment is performed using independent mail centers, supermarkets or other retailers can be another extension of sub franchise.

### DETAILED DESCRIPTION OF THE INVENTION

Reference 1 provides details of Cell-A-Lot™ where a method of ticketing retaining anonymity, authenticity and security is described. Method and Apparatus for customer loyalty program for airline ticketing, ticketing for games, Disney, car rentals and general retailing is described in provisional patent application 60/510,400 Oct. 14, 2003. The disclosed method uses

a) Product sales directly on wireless devices instead of Internet, providing anytime anywhere capability.
b) Regulated lottery ticket or other suitable product as a secondary product, which enhances primary product sales enhancements and advertisement opportunity.
c) Sale of regulated lottery ticket on Internet and wireless devices such as cell phones and Pads using lottery pooling, where people buy lottery tickets using rules and guidelines established by the pool.

These claims are described in detail below.

### TECHNOLOGY

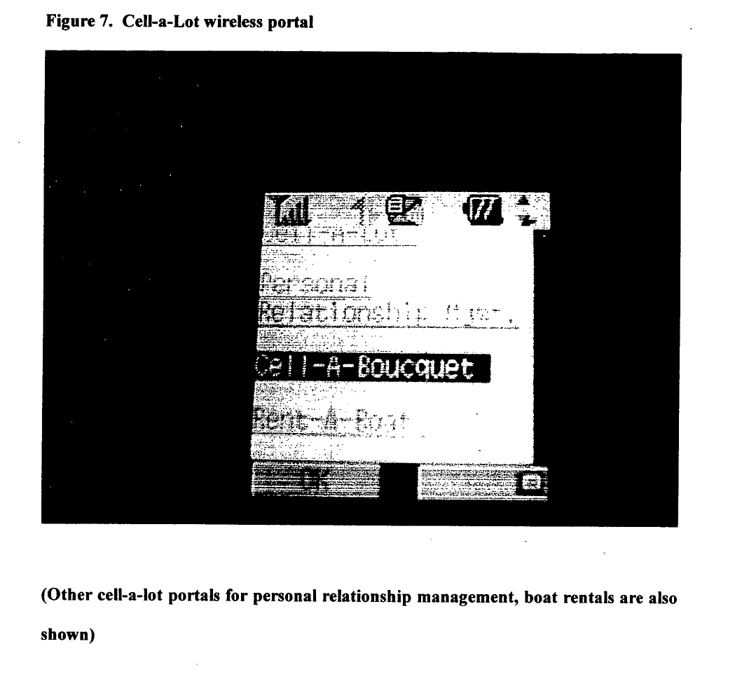

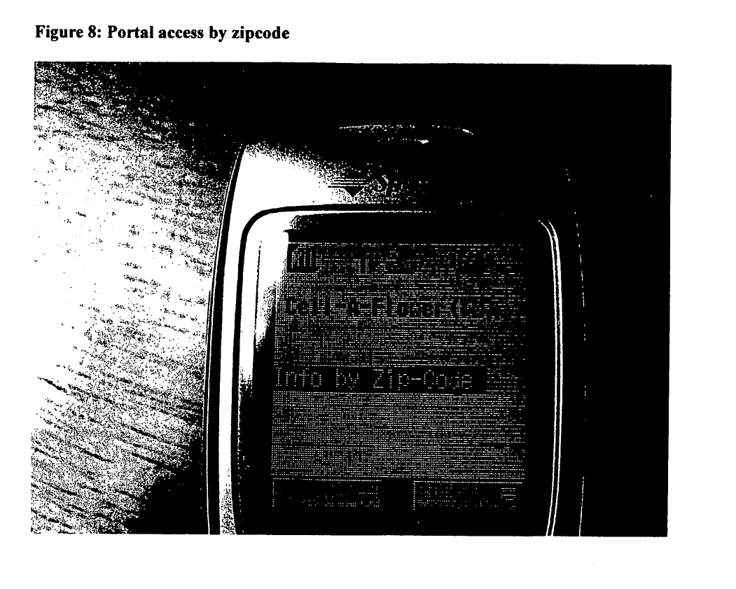

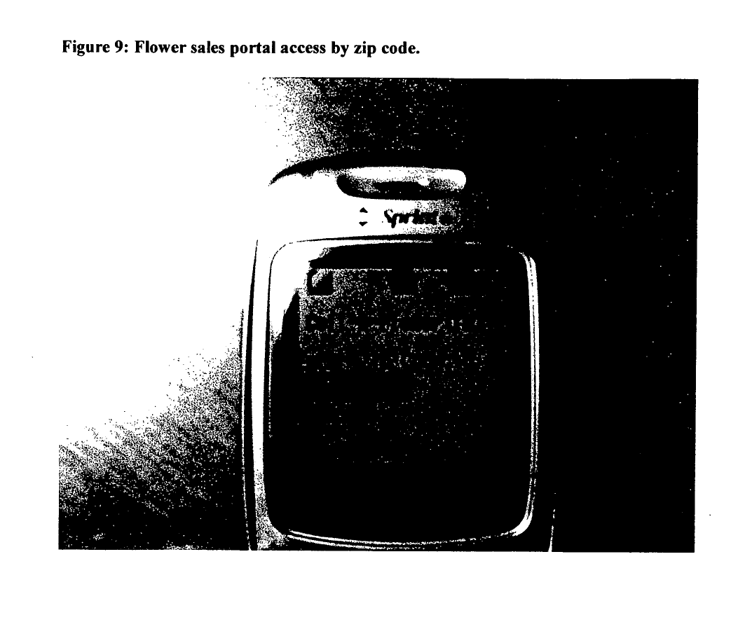

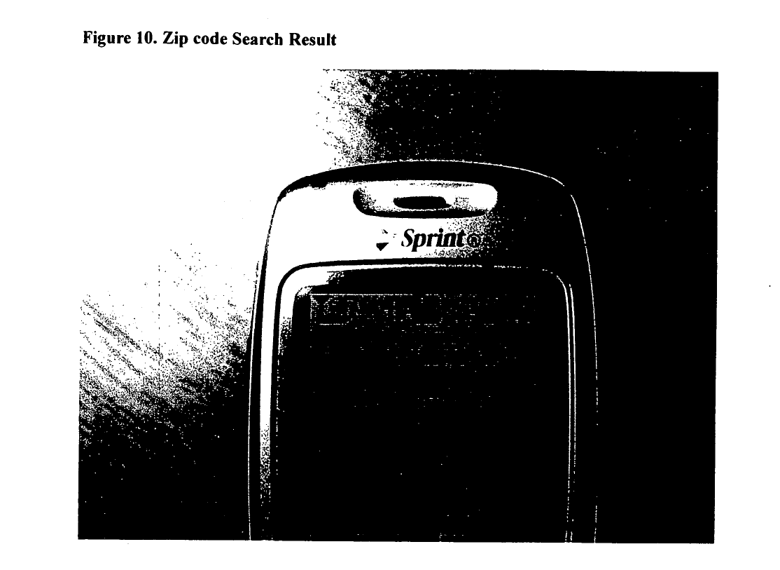

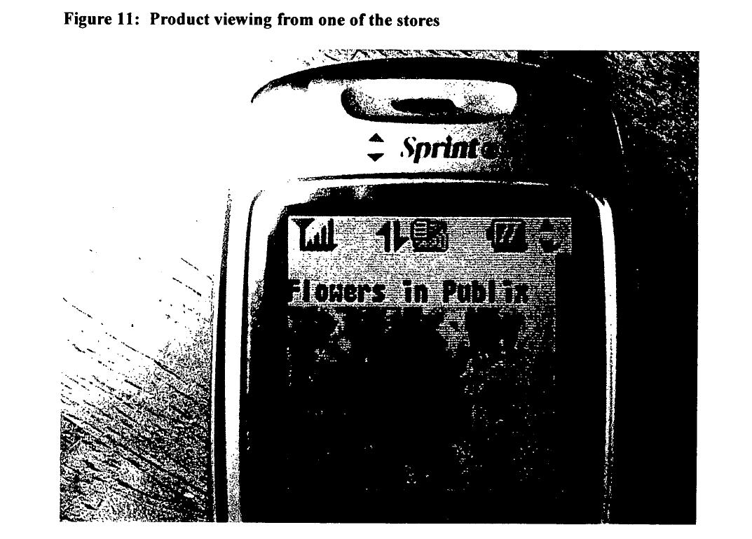

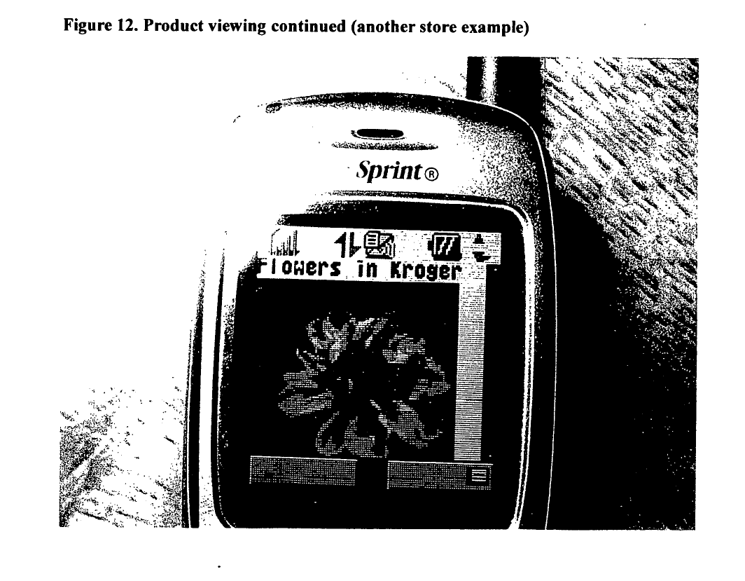

Cell-A-Lot technology described in reference 1 will provide anytime anywhere multimode transaction process possible. Customer can make purchases via phone, remote devices or Internet using single integrated system. Cell-A-Lot has a backend system, which is fully integrated with a) financial transaction, b) wireless, c) VOIP, d) web services database engines. The computer system can process or respond to a combination of text, alphanumeric and audiovisual inputs. Text/data input will get processed through secure internet or Secure Socket Layer depending on the situation. Voice information will get processed through Voice Over Internet Protocol and any time anywhere data access occurs through Wireless Access Protocol (WAP). Cell-A-Lot architecture is shown in FIG. 1. Cell-A-Lot was one of the first services to offer zip code wireless search. An application of cell-A-lot product sale application is shown in FIGS. 2-through 6. Here example of identification of a specific store in a zipcode and a specific product item are shown as an example. While a Personal Data Assistant (PDA) Application is shown in FIGS. 2-6, the same application also works on a web connected cell phone also. Cell phone applications are shown in FIGS. 7 through 14. FIG. 7 shows cell-a-lot wireless portal. FIG. 8 shows search by zip code. FIG. 9 shows data entry example. Here zip code is entered using cell phone and the resulting search is shown in FIG. 10. FIGS. 11 and 12 just show examples from each of these stores, after a particular selection within a store has been made (product shows as is, because of imaging issues, product is not that clear).

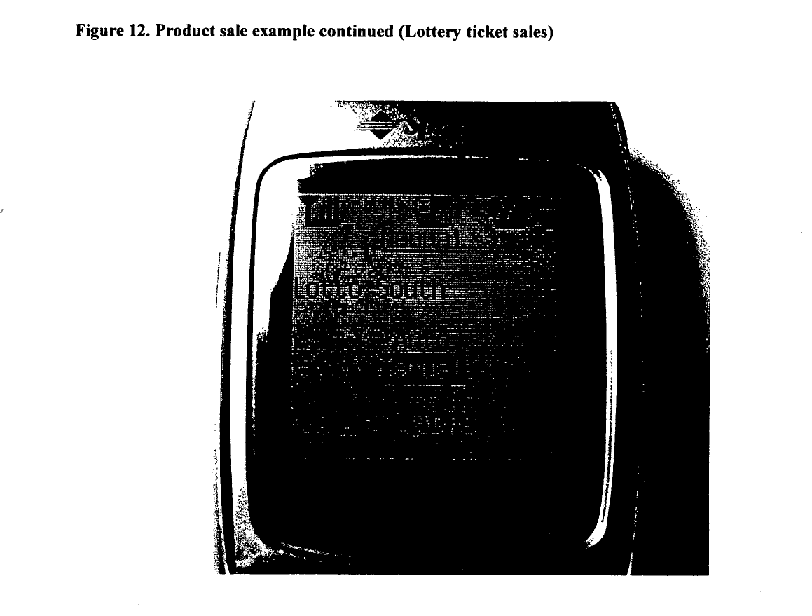

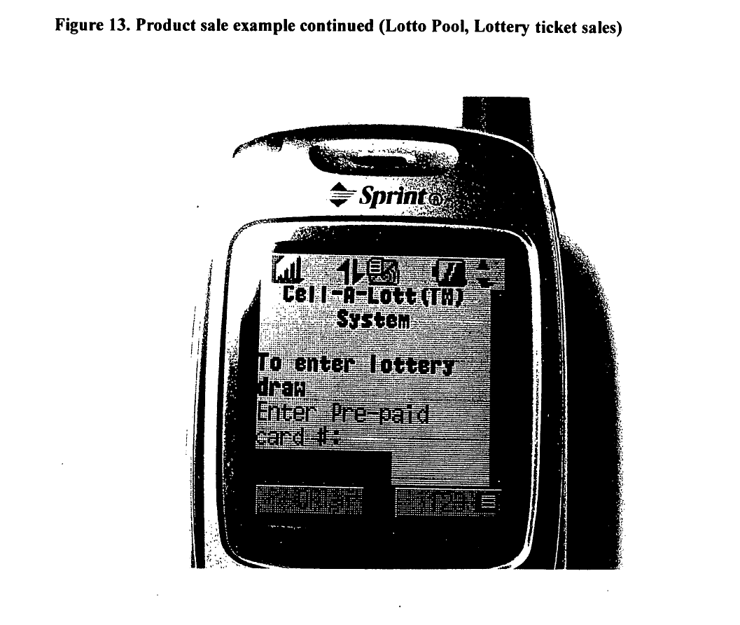

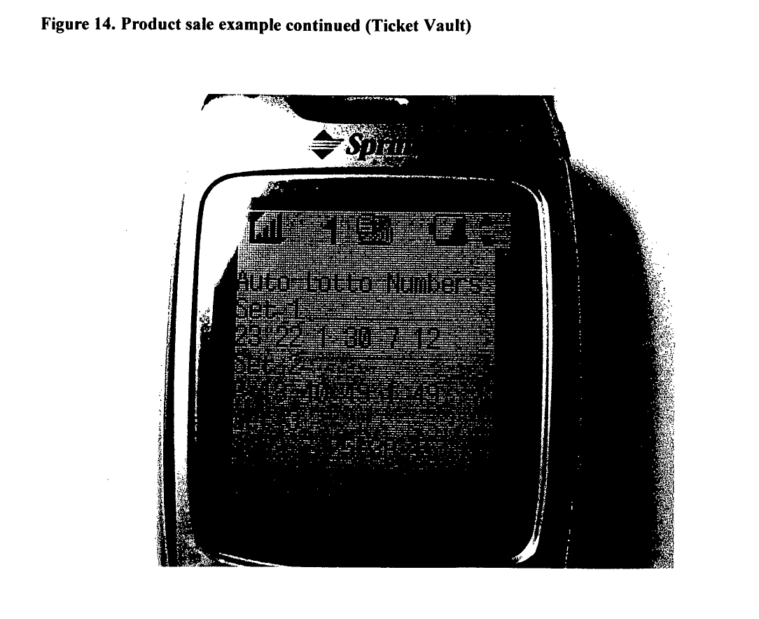

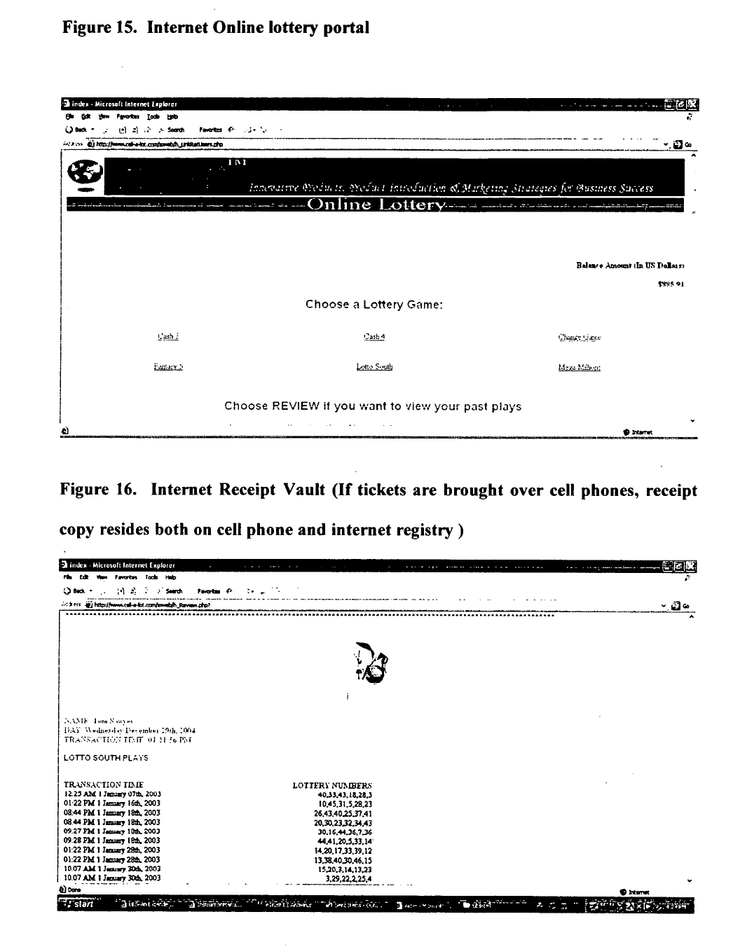

FIG. 12 shows another example of lottery ticket purchase through cell phone. More technical details of steps leading up to this is shown in FIG. 12. FIG. 13 shows purchase of lottery ticket using a prepaid card and FIG. 14 shows a set of numbers purchased. These transactions not only are saved on the cell phones, but also on the Internet at the same time. Actual tickets can be redeemed at participating stores. A cell-a-lot pool works on the principal of ticket pooling. Rules and guidelines of the pool follow individual state regulations. Instead of a typical pool where multiple individuals or a team share tickets purchase, cell-a-lot pool applies to both individual or team purchases. Internet or wireless devices act as purchase mechanism. Cell-a-lot provides anytime anywhere purchase capability, without having to stand inline, or keep track of tickets. Purchasing agent or pool representative act as ticketing agent. Cell-a-lot pool participants who have winning tickets will be contacted to visit the store to pick up the tickets or prizes. However participants can also visit the store anytime to pickup their tickets. Internet portal for ticket purchase and ticket vaults are shown in FIGS. 15 and 16 respectively. Even though multiple records of transaction exist, they are only proof of purchase registry. All transaction can be registered on customer loyalty card, prepaid card or lotto card reference basis as allowed by pool and state regulations.

A combination of both method and apparatus cover the intellectual property.

### REFERENCES

1. Patent Application # 60/402,812 Dated Aug. 12, 2002
2. Method and Apparatus for customer loyalty program. Patent Pending 60/510,400 Oct. 14, 2003.

1. Anytime anywhere transaction portal Cell-A-Lot computer system. The computer system integrates a combination of back end, scheduled and post processing which makes a combination of transactions possible using text, alphanumeric, audiovisual inputs and outputs on a combination of standalone, networked, internet or wireless electronic or computer systems or gadgets. Sale items could be gifts such as flower to major product sale initiation process such as boats or house sales.

2. Regulated lottery ticket or other suitable product as a secondary product, which enhances primary product sales enhancements and advertisement opportunity. This could include such product sale examples as: a) entertainment product sales (audio, video or movie rentals), b) gifts such as flowers, perfume, wine etc.

3. Regulated lottery ticket sale using Internet and Wireless devices where ticket sales are generated using ticket pooling methods. Ticket pooling could involve sale of tickets to individuals or a group of people, but rules and guidelines allow purchase and or redeeming of tickets remotely. In some situations customers may still need to go to store to purchase tickets.
Claim 1 permits anytime anywhere purchase mechanism. In those situations where remote purchasing is not possible, following pool rules and guidelines products will be delivered via mail or through a purchasing agent.
